SEQUENCE LISTING (253 sequences)

SEQ ID NO: 1 - protein, 6 aa, Gallus gallus
FGLSGL

SEQ ID NO: 2 - protein, 7 aa, Gallus gallus
AAVGSSL

SEQ ID NO: 3 - protein, 7 aa, Gallus gallus
TAVGSST

SEQ ID NO: 4 - protein, 6 aa, Gallus gallus
LSLSSQ

SEQ ID NO: 5 - protein, 7 aa, Gallus gallus
FGISGLG

SEQ ID NO: 6 - protein, 6 aa, Gallus gallus
PILSSF

SEQ ID NO: 7 - protein, 7 aa, Gallus gallus
SLLSQGA

SEQ ID NO: 8 - protein, 6 aa, Gallus gallus
FNLRGA

SEQ ID NO: 9 - protein, 8 aa, Gallus gallus
SAAVGSSL

SEQ ID NO: 10 - protein, 6 aa, Gallus gallus
SRVVIQ

SEQ ID NO: 11 - protein, 6 aa, Gallus gallus
SRVVLE

SEQ ID NO: 12 - protein, 8 aa, Gallus gallus
GFGISGLG

SEQ ID NO: 13 - protein, 6 aa, Gallus gallus
SRFSGR

SEQ ID NO: 14 - protein, 6 aa, Gallus gallus
RVVIQP

SEQ ID NO: 15 - protein, 8 aa, Gallus gallus
SAAVGSIL

SEQ ID NO: 16 - protein, 7 aa, Gallus gallus
IVVIGHV

SEQ ID NO: 17 - protein, 9 aa, Gallus gallus
TAVGSSTSA

SEQ ID NO: 18 - protein, 7 aa, Gallus gallus
RVVIQPS

SEQ ID NO: 19 - protein, 7 aa, Gallus gallus
SRVVIQP

SEQ ID NO: 20 - protein, 7 aa, Gallus gallus
PQGEQLQ

SEQ ID NO: 21 - protein, 9 aa, Gallus gallus
RAGAGPPSP

SEQ ID NO: 22 - protein, 7 aa, Gallus gallus
DSRVVIQ

SEQ ID NO: 23 - protein, 8 aa, Gallus gallus
PGPILSSF

SEQ ID NO: 24 - protein, 9 aa, Gallus gallus
PISSGGFGI

SEQ ID NO: 25 - protein, 8 aa, Gallus gallus
ISGLGSRF

SEQ ID NO: 26 - protein, 10 aa, Gallus gallus
SGGFGISGLG

SEQ ID NO: 27 - protein, 7 aa, Gallus gallus
SRFSGRR

SEQ ID NO: 28 - protein, 9 aa, Gallus gallus
PGLALPVLP

SEQ ID NO: 29 - protein, 8 aa, Gallus gallus
SRVVIQPS

SEQ ID NO: 30 - protein, 8 aa, Gallus gallus
PILSSFPQ

SEQ ID NO: 31 - protein, 8 aa, Gallus gallus
LGSGIFWI

SEQ ID NO: 32 - protein, 9 aa, Gallus gallus
GISGLGSRF

SEQ ID NO: 33 - protein, 9 aa, Gallus gallus
VVVTLPGPI

SEQ ID NO: 34 - protein, 8 aa, Gallus gallus
CRLSLSQP

SEQ ID NO: 35 - protein, 11 aa, Gallus gallus
SAAVGSSLSAG

SEQ ID NO: 36 - protein, 11 aa, Gallus gallus
AVGSSTSAAVG

SEQ ID NO: 37 - protein, 9 aa, Gallus gallus
VVTLPGPIL

SEQ ID NO: 38 - protein, 9 aa, Gallus gallus
PGPILSSFP

SEQ ID NO: 39 - protein, 10 aa, Gallus gallus
SAAVGSILSE

SEQ ID NO: 40 - protein, 10 aa, Gallus gallus
VPISSGGFGI

SEQ ID NO: 41 - protein, 8 aa, Gallus gallus
QLAQRNTI

SEQ ID NO: 42 - protein, 9 aa, Gallus gallus
LSGLRSNLS

SEQ ID NO: 43 - protein, 10 aa, Gallus gallus
PSPVVVTLPG

SEQ ID NO: 44 - protein, 10 aa, Gallus gallus
PPPVVVTLPG

SEQ ID NO: 45 - protein, 10 aa, Gallus gallus
ISGLGSRFSG

SEQ ID NO: 46 - protein, 9 aa, Gallus gallus
LALRQSVEA

SEQ ID NO: 47 - protein, 10 aa, Gallus gallus
PLLGPPLLGI

SEQ ID NO: 48 - protein, 10 aa, Gallus gallus
VVTLPGPILS

SEQ ID NO: 49 - protein, 8 aa, Gallus gallus
VTLEDLRR

SEQ ID NO: 50 - protein, 9 aa, Gallus gallus
PILSSFPQN

SEQ ID NO: 51 - protein, 9 aa, Gallus gallus
PILSSFPQD

SEQ ID NO: 52 - protein, 11 aa, Gallus gallus
GTVGVSAGVTR

SEQ ID NO: 53 - protein, 9 aa, Gallus gallus
FGLSRVTLN

SEQ ID NO: 54 - protein, 12 aa, Gallus gallus
TAVGSSTSAAVG

SEQ ID NO: 55 - protein, 10 aa, Gallus gallus
VVVTLPGPIL

SEQ ID NO: 56 - protein, 10 aa, Gallus gallus
PPVVVTFPGP

SEQ ID NO: 57 - protein, 10 aa, Gallus gallus
PPPVVVTFPG

SEQ ID NO: 58 - protein, 10 aa, Gallus gallus
VVIQPSPVVV

SEQ ID NO: 59 - protein, 10 aa, Gallus gallus
FGISGLGSRF

SEQ ID NO: 60 - protein, 10 aa, Gallus gallus
PGPILSSFPQ

SEQ ID NO: 61 - protein, 10 aa, Gallus gallus
FGWSGLGRGL

SEQ ID NO: 62 - protein, 9 aa, Gallus gallus
LEAQLSELR

SEQ ID NO: 63 - protein, 9 aa, Gallus gallus
IVGAWYTVR

SEQ ID NO: 64 - protein, 11 aa, Gallus gallus
LLSPPGLPGLL

SEQ ID NO: 65 - protein, 11 aa, Gallus gallus
VVVTLPGPILS

SEQ ID NO: 66 - protein, 11 aa, Gallus gallus
GFGISGLGSRF

SEQ ID NO: 67 - protein, 11 aa, Gallus gallus
PVVVTLPGPIL

SEQ ID NO: 68 - protein, 11 aa, Gallus gallus
VSQGEITVPSI

SEQ ID NO: 69 - protein, 11 aa, Gallus gallus
SILSEEGVPIS

SEQ ID NO: 70 - protein, 11 aa, Gallus gallus
PVVVTFPGPIL

SEQ ID NO: 71 - protein, 13 aa, Gallus gallus
PISSGGFGISGLG

SEQ ID NO: 72 - protein, 13 aa, Gallus gallus
VGSSTSAAVGSIL

SEQ ID NO: 73 - protein, 11 aa, Gallus gallus
GFLSSAVSLNR

SEQ ID NO: 74 - protein, 12 aa, Gallus gallus
GGFGISGLGSRF

SEQ ID NO: 75 - protein, 11 aa, Gallus gallus
PGPILSSFPQN

SEQ ID NO: 76 - protein, 11 aa, Gallus gallus
PGPILSSFPQD

SEQ ID NO: 77 - protein, 12 aa, Gallus gallus
GGFGWSGLGRGL

SEQ ID NO: 78 - protein, 12 aa, Gallus gallus
PSPVVVTLPGPI

SEQ ID NO: 79 - protein, 12 aa, Gallus gallus
VVVTLPGPILSS

SEQ ID NO: 80 - protein, 12 aa, Gallus gallus
PVVVTLPGPILS

SEQ ID NO: 81 - protein, 12 aa, Gallus gallus
SPVVVTLPGPIL

SEQ ID NO: 82 - protein, 11 aa, Gallus gallus
RVVIQPSPVVV

SEQ ID NO: 83 - protein, 11 aa, Gallus gallus
QALTEVYAKAN

SEQ ID NO: 84 - protein, 10 aa, Gallus gallus
IETLTQFLGW

SEQ ID NO: 85 - protein, 13 aa, Gallus gallus
GFGSRSLVGLGGT

SEQ ID NO: 86 - protein, 14 aa, Gallus gallus
AVGSSTSAAVGSIL

SEQ ID NO: 87 - protein, 12 aa, Gallus gallus
PVVVTFPGPILS

SEQ ID NO: 88 - protein, 14 aa, Gallus gallus
VGSSTSAAVGSILS

SEQ ID NO: 89 - protein, 13 aa, Gallus gallus
GFGISGLGSRFSG

SEQ ID NO: 90 - protein, 13 aa, Gallus gallus
SGGFGISGLGSRF

SEQ ID NO: 91 - protein, 14 aa, Gallus gallus
VPISSGGFGISGLG

SEQ ID NO: 92 - protein, 12 aa, Gallus gallus
VVIQPSPVVVTL

SEQ ID NO: 93 - protein, 13 aa, Gallus gallus
SILSEEGVPISSG

SEQ ID NO: 94 - protein, 13 aa, Gallus gallus
VMGCKAAGASRII

SEQ ID NO: 95 - protein, 13 aa, Gallus gallus
SPVVVTLPGPILS

SEQ ID NO: 96 - protein, 12 aa, Gallus gallus
SRVVIQPSPVVV

SEQ ID NO: 97 - protein, 13 aa, Gallus gallus
PSPVVVTLPGPIL

SEQ ID NO: 98 - protein, 12 aa, Gallus gallus
RVVIQPSPVVVT

SEQ ID NO: 99 - protein, 13 aa, Gallus gallus
PPPVVVTLPGPIL

SEQ ID NO: 100 - protein, 15 aa, Gallus gallus
GVPISSGGFGISGLG

SEQ ID NO: 101 - protein, 13 aa, Gallus gallus
VIQPSPVVVTLPG

SEQ ID NO: 102 - protein, 15 aa, Gallus gallus
AVGSSTSAAVGSILS

SEQ ID NO: 103 - protein, 15 aa, Gallus gallus
TAVGSSTSAAVGSIL

SEQ ID NO: 104 - protein, 14 aa, Gallus gallus
SGGFGISGLGSRFS

SEQ ID NO: 105 - protein, 13 aa, Gallus gallus
VVVTLPGPILSSF

SEQ ID NO: 106 - protein, 13 aa, Gallus gallus
PPPVVVTFPGPIL

SEQ ID NO: 107 - protein, 14 aa, Gallus gallus
GLGGFGWSGLGRGL

SEQ ID NO: 108 - protein, 13 aa, Gallus gallus
VTLPGPILSSFPQ

SEQ ID NO: 109 - protein, 14 aa, Gallus gallus
AVGSILSEEGVPIS

SEQ ID NO: 110 - protein, 14 aa, Gallus gallus
SLGLGGFGWSGLGR

SEQ ID NO: 111 - protein, 14 aa, Gallus gallus
PSPVVVTLPGPILS

SEQ ID NO: 112 - protein, 13 aa, Gallus gallus
SRVVIQPSPVVVT

SEQ ID NO: 113 - protein, 15 aa, Gallus gallus
SGGFGISGLGSRFSG

SEQ ID NO: 114 - protein, 14 aa, Gallus gallus
PPPVVVTLPGPILS

SEQ ID NO: 115 - protein, 14 aa, Gallus gallus
VAIQPPPVVVTLPG

SEQ ID NO: 116 - protein, 15 aa, Gallus gallus
PISSGGFGISGLGSR

SEQ ID NO: 117 - protein, 13 aa, Gallus gallus
PIVDVAEALLHVK

SEQ ID NO: 118 - protein, 14 aa, Gallus gallus
VVIQPSPVVVTLPG

SEQ ID NO: 119 - protein, 13 aa, Gallus gallus
RVVIQPSPVVVTL

SEQ ID NO: 120 - protein, 16 aa, Gallus gallus
TAVGSSTSAAVGSILS

SEQ ID NO: 121 - protein, 14 aa, Gallus gallus
PPPVVVTFPGPILS

SEQ ID NO: 122 - protein, 15 aa, Gallus gallus
SLGLGGFGWSGLGRG

SEQ ID NO: 123 - protein, 14 aa, Gallus gallus
VVVTLPGPILSSFP

SEQ ID NO: 124 - protein, 14 aa, Gallus gallus
PVVVTLPGPILSSF

SEQ ID NO: 125 - protein, 15 aa, Gallus gallus
AAVGSILSEEGVPIS

SEQ ID NO: 126 - protein, 15 aa, Gallus gallus
SAAVGSILSEEGVPI

SEQ ID NO: 127 - protein, 16 aa, Gallus gallus
EGVPISSGGFGISGLG

SEQ ID NO: 128 - protein, 14 aa, Gallus gallus
VVTLPGPILSSFPQ

SEQ ID NO: 129 - protein, 15 aa, Gallus gallus
PSPVVVTLPGPILSS

SEQ ID NO: 130 - protein, 16 aa, Gallus gallus
GKDGPKGVRGDAGPPG

SEQ ID NO: 131 - protein, 15 aa, Gallus gallus
SVAIQPPPVVVTLPG

SEQ ID NO: 132 - protein, 14 aa, Gallus gallus
SRVVIQPSPVVVTL

SEQ ID NO: 133 - protein, 14 aa, Gallus gallus
LHTEAAATVPDRSE

SEQ ID NO: 134 - protein, 15 aa, Gallus gallus
VVIQPSPVVVTLPGP

SEQ ID NO: 135 - protein, 14 aa, Gallus gallus
RVVIQPSPVVVTLP

SEQ ID NO: 136 - protein, 16 aa, Gallus gallus
SAAVGSILSEEGVPIS

SEQ ID NO: 137 - protein, 15 aa, Gallus gallus
PVVVTLPGPILSSFP

SEQ ID NO: 138 - protein, 15 aa, Gallus gallus
IQPSPVVVTLPGPIL

SEQ ID NO: 139 - protein, 17 aa, Gallus gallus
SVPIGAGGSLGLGGFGW

SEQ ID NO: 140 - protein, 16 aa, Gallus gallus
SLGLGGFGWSGLGRGL

SEQ ID NO: 141 - protein, 17 aa, Gallus gallus
FGGGFGGGDGILPAGEK

SEQ ID NO: 142 - protein, 17 aa, Gallus gallus
TAVGSSTSAAVGSILSE

SEQ ID NO: 143 - protein, 16 aa, Gallus gallus
PISSGGFGISGLGSRF

SEQ ID NO: 144 - protein, 19 aa, Gallus gallus
SAAVGSSLSAGSVPIGAGG

SEQ ID NO: 145 - protein, 17 aa, Gallus gallus
GVPISSGGFGISGLGSR

SEQ ID NO: 146 - protein, 15 aa, Gallus gallus
VVVTLPGPILSSFPQ

SEQ ID NO: 147 - protein, 15 aa, Gallus gallus
RVVIQPSPVVVTLPG

SEQ ID NO: 148 - protein, 15 aa, Gallus gallus
SRVVIQPSPVVVTLP

SEQ ID NO: 149 - protein, 16 aa, Gallus gallus
PSPVVVTLPGPILSSF

SEQ ID NO: 150 - protein, 16 aa, Gallus gallus
AIQPPPVVVTLPGPIL

SEQ ID NO: 151 - protein, 16 aa, Gallus gallus
IQPSPVVVTLPGPILS

SEQ ID NO: 152 - protein, 16 aa, Gallus gallus
VIQPSPVVVTLPGPIL

SEQ ID NO: 153 - protein, 17 aa, Gallus gallus
VPISSGGFGISGLGSRF

SEQ ID NO: 154 - protein, 16 aa, Gallus gallus
SRVVIQPSPVVVTLPG

SEQ ID NO: 155 - protein, 17 aa, Gallus gallus
SILSEEGVPISSGGFGI

SEQ ID NO: 156 - protein, 16 aa, Gallus gallus
PVVVTLPGPILSSFPQ

SEQ ID NO: 157 - protein, 16 aa, Gallus gallus
RVVIQPSPVVVTLPGP

SEQ ID NO: 158 - protein, 18 aa, Gallus gallus
SAAVGSILSEEGVPISSG

SEQ ID NO: 159 - protein, 16 aa, Gallus gallus
VVVTLPGPILSSFPQN

SEQ ID NO: 160 - protein, 18 aa, Gallus gallus
GVPISSGGFGISGLGSRF

SEQ ID NO: 161 - protein, 17 aa, Gallus gallus
PSPVVVTLPGPILSSFP

SEQ ID NO: 162 - protein, 17 aa, Gallus gallus
VAIQPPPVVVTLPGPIL

SEQ ID NO: 163 - protein, 17 aa, Gallus gallus
VIQPSPVVVTLPGPILS

SEQ ID NO: 164 - protein, 17 aa, Gallus gallus
VVIQPSPVVVTLPGPIL

SEQ ID NO: 165 - protein, 17 aa, Gallus gallus
SPVVVTLPGPILSSFPQ

SEQ ID NO: 166 - protein, 15 aa, Gallus gallus
VILSNTKTQYSIKIH

SEQ ID NO: 167 - protein, 17 aa, Gallus gallus
SRVVIQPSPVVVTLPGP

SEQ ID NO: 168 - protein, 17 aa, Gallus gallus
DSRVVIQPSPVVVTLPG

SEQ ID NO: 169 - protein, 17 aa, Gallus gallus
PVVVTLPGPILSSFPQN

SEQ ID NO: 170 - protein, 17 aa, Gallus gallus
RVVIQPSPVVVTLPGPI

SEQ ID NO: 171 - protein, 19 aa, Gallus gallus
GVPISSGGFGISGLGSRFS

SEQ ID NO: 172 - protein, 18 aa, Gallus gallus
SVAIQPPPVVVTLPGPIL

SEQ ID NO: 173 - protein, 18 aa, Gallus gallus
VAIQPPPVVVTLPGPILS

SEQ ID NO: 174 - protein, 18 aa, Gallus gallus
VVIQPSPVVVTLPGPILS

SEQ ID NO: 175 - protein, 18 aa, Gallus gallus
PSPVVVTLPGPILSSFPQ

SEQ ID NO: 176 - protein, 20 aa, Gallus gallus
GVPISSGGFGISGLGSRFSG

SEQ ID NO: 177 - protein, 18 aa, Gallus gallus
AVPLVRPVTMVPSIPGIP

SEQ ID NO: 178 - protein, 18 aa, Gallus gallus
PPPVVVTLPGPILSSFPQ

SEQ ID NO: 179 - protein, 18 aa, Gallus gallus
SPVVVTLPGPILSSFPQN

SEQ ID NO: 180 - protein, 18 aa, Gallus gallus
LPGPGLQLLHGTTTLAFK

SEQ ID NO: 181 - protein, 18 aa, Gallus gallus
PPPVVVTFPGPILSSFPQ

SEQ ID NO: 182 - protein, 19 aa, Gallus gallus
SVAIQPPPVVVTLPGPILS

SEQ ID NO: 183 - protein, 19 aa, Gallus gallus
SSVAIQPPPVVVTLPGPIL

SEQ ID NO: 184 - protein, 18 aa, Gallus gallus
RVVIQPSPVVVTLPGPIL

SEQ ID NO: 185 - protein, 19 aa, Gallus gallus
PSPVVVTLPGPILSSFPQN

SEQ ID NO: 186 - protein, 21 aa, Gallus gallus
SILSEEGVPISSGGFGISGLG

SEQ ID NO: 187 - protein, 19 aa, Gallus gallus
SRVVIQPSPVVVTLPGPIL

SEQ ID NO: 188 - protein, 19 aa, Gallus gallus
RVVIQPSPVVVTLPGPILS

SEQ ID NO: 189 - protein, 22 aa, Gallus gallus
SVPIGAGGSLGLGGFGWSGLGR

SEQ ID NO: 190 - protein, 22 aa, Gallus gallus
TAVGSSTSAAVGSILSEEGVPI

SEQ ID NO: 191 - protein, 22 aa, Gallus gallus
SAAVGSILSEEGVPISSGGFGI

SEQ ID NO: 192 - protein, 21 aa, Gallus gallus
SEEGVPISSGGFGISGLGSRF

SEQ ID NO: 193 - protein, 20 aa, Gallus gallus
SRVVIQPSPVVVTLPGPILS

SEQ ID NO: 194 - protein, 23 aa, Gallus gallus
SVPIGAGGSLGLGGFGWSGLGRG

SEQ ID NO: 195 - protein, 20 aa, Gallus gallus
DSRVVIQPSPVVVTLPGPIL

SEQ ID NO: 196 - protein, 23 aa, Gallus gallus
TAVGSSTSAAVGSILSEEGVPIS

SEQ ID NO: 197 - protein, 22 aa, Gallus gallus
LRGDVGPVGRTGEQGIAGPPGF

SEQ ID NO: 198 - protein, 21 aa, Gallus gallus
SRVVIQPSPVVVTLPGPILSS

SEQ ID NO: 199 - protein, 21 aa, Gallus gallus
VVIQPSPVVVTLPGPILSSFP

SEQ ID NO: 200 - protein, 22 aa, Gallus gallus
GVPISSGGFGISGLGSRFSGRR

SEQ ID NO: 201 - protein, 24 aa, Gallus gallus
SVPIGAGGSLGLGGFGWSGLGRGL

SEQ ID NO: 202 - protein, 21 aa, Gallus gallus
DSRVVIQPSPVVVTLPGPILS

SEQ ID NO: 203 - protein, 21 aa, Gallus gallus
VIQPSPVVVTLPGPILSSFPQ

SEQ ID NO: 204 - protein, 24 aa, Gallus gallus
AVGSILSEEGVPISSGGFGISGLG

SEQ ID NO: 205 - protein, 21 aa, Gallus gallus
RVVIQPSPVVVTLPGPILSSF

SEQ ID NO: 206 - protein, 23 aa, Gallus gallus
SILSEEGVPISSGGFGISGLGSR

SEQ ID NO: 207 - protein, 21 aa, Gallus gallus
IPSSVPESSFKIKGNSSSFHI

SEQ ID NO: 208 - protein, 22 aa, Gallus gallus
VAIQPPPVVVTLPGPILSSFPQ

SEQ ID NO: 209 - protein, 25 aa, Gallus gallus
TAVGSSTSAAVGSILSEEGVPISSG

SEQ ID NO: 210 - protein, 22 aa, Gallus gallus
VVIQPSPVVVTLPGPILSSFPQ

SEQ ID NO: 211 - protein, 23 aa, Gallus gallus
PSPVVVTLPGPILSSFPQNTAVG

SEQ ID NO: 212 - protein, 20 aa, Gallus gallus
KENFEVLCKDGTRKPVTDAE

SEQ ID NO: 213 - protein, 21 aa, Gallus gallus
SIQACKLAQSHGWGVMVSHRS

SEQ ID NO: 214 - protein, 22 aa, Gallus gallus
SRVVIQPSPVVVTLPGPILSSF

SEQ ID NO: 215 - protein, 22 aa, Gallus gallus
RVVIQPSPVVVTLPGPILSSFP

SEQ ID NO: 216 - protein, 23 aa, Gallus gallus
EQPPLCVASVSVKEPASETPAVP

SEQ ID NO: 217 - protein, 23 aa, Gallus gallus
SVAIQPPPVVVTLPGPILSSFPQ

SEQ ID NO: 218 - protein, 26 aa, Gallus gallus
SAAVGSILSEEGVPISSGGFGISGLG

SEQ ID NO: 219 - protein, 24 aa, Gallus gallus
SILSEEGVPISSGGFGISGLGSRF

SEQ ID NO: 220 - protein, 24 aa, Gallus gallus
PSPVVVTLPGPILSSFPQNTAVGS

SEQ ID NO: 221 - protein, 23 aa, Gallus gallus
VVIQPSPVVVTLPGPILSSFPQN

SEQ ID NO: 222 - protein, 23 aa, Gallus gallus
SRVVIQPSPVVVTLPGPILSSFP

SEQ ID NO: 223 - protein, 24 aa, Gallus gallus
SSVAIQPPPVVVTLPGPILSSFPQ

SEQ ID NO: 224 - protein, 23 aa, Gallus gallus
RVVIQPSPVVVTLPGPILSSFPQ

SEQ ID NO: 225 - protein, 25 aa, Gallus gallus
SILSEEGVPISSGGFGISGLGSRFS

SEQ ID NO: 226 - protein, 27 aa, Gallus gallus
TSAAVGSILSEEGVPISSGGFGISGLG

SEQ ID NO: 227 - protein, 26 aa, Gallus gallus
SILSEEGVPISSGGFGISGLGSRFSG

SEQ ID NO: 228 - protein, 24 aa, Gallus gallus
SRVVIQPSPVVVTLPGPILSSFPQ

SEQ ID NO: 229 - protein, 28 aa, Gallus gallus
TAVGSSTSAAVGSILSEEGVPISSGGFG

SEQ ID NO: 230 - protein, 28 aa, Gallus gallus
STSAAVGSILSEEGVPISSGGFGISGLG

SEQ ID NO: 231 - protein, 24 aa, Gallus gallus
RVVIQPSPVVVTLPGPILSSFPQN

SEQ ID NO: 232 - protein, 25 aa, Gallus gallus
SRVVIQPSPVVVTLPGPILSSFPQN

SEQ ID NO: 233 - protein, 25 aa, Gallus gallus
DSRVVIQPSPVVVTLPGPILSSFPQ

SEQ ID NO: 234 - protein, 29 aa, Gallus gallus
TAVGSSTSAAVGSILSEEGVPISSGGFGI

SEQ ID NO: 235 - protein, 29 aa, Gallus gallus
SAAVGSILSEEGVPISSGGFGISGLGSRF

SEQ ID NO: 236 - protein, 24 aa, Gallus gallus
VEQLVNLQHLDVAYNLLLEHAQLA

SEQ ID NO: 237 - protein, 28 aa, Gallus gallus
SVAIQPPPVVVTLPGPILSSFPQSTAVG

SEQ ID NO: 238 - protein, 28 aa, Gallus gallus
SILSEEGVPISSGGFGISGLGSRFSGRR

SEQ ID NO: 239 - protein, 30 aa, Gallus gallus
TSAAVGSILSEEGVPISSGGFGISGLGSRF

SEQ ID NO: 240 - protein, 29 aa, Gallus gallus
SSVAIQPPPVVVTLPGPILSSFPQSTAVG

SEQ ID NO: 241 - protein, 31 aa, Gallus gallus
STSAAVGSILSEEGVPISSGGFGISGLGSRF

SEQ ID NO: 242 - protein, 31 aa, Gallus gallus
PSPVVVTLPGPILSSFPQNTAVGSSTSAAVG

SEQ ID NO: 243 - protein, 33 aa, Gallus gallus
TAVGSSTSAAVGSILSEEGVPISSGGFGISGLG

SEQ ID NO: 244 - protein, 31 aa, Gallus gallus
AVGSILSEEGVPISSGGFGISGLGSRFSGRR

SEQ ID NO: 245 - protein, 27 aa, Gallus gallus
NKVLVHCAMGRSRSATLVLAYLMIYKN

SEQ ID NO: 246 - protein, 32 aa, Gallus gallus
SSVAIQPPPVVVTLPGPILSSFPQSTAVGSTA

SEQ ID NO: 247 - protein, 32 aa, Gallus gallus
AAVGSILSEEGVPISSGGFGISGLGSRFSGRR

SEQ ID NO: 248 - protein, 35 aa, Gallus gallus
TAVGSSTSAAVGSILSEEGVPISSGGFGISGLGSR

SEQ ID NO: 249 - protein, 33 aa, Gallus gallus
SAAVGSILSEEGVPISSGGFGISGLGSRFSGRR

SEQ ID NO: 250 - protein, 34 aa, Gallus gallus
PSPVVVTLPGPILSSFPQNTAVGSSTSAAVGSIL

SEQ ID NO: 251 - protein, 35 aa, Gallus gallus
PSPVVVTLPGPILSSFPQNTAVGSSTSAAVGSILS

SEQ ID NO: 252 - protein, 36 aa, Gallus gallus
TAVGSSTSAAVGSILSEEGVPISSGGFGISGLGSRF

SEQ ID NO: 253 - protein, 29 aa, Gallus gallus
RPRVYLHCTNPRHPKYREGDVTLFALNLS

(19) United States
(12) Patent Application Publication
(10) Pub. No.: US 2025/0212892 A1
(43) Pub. Date: Jul. 3, 2025

(54) USE OF THERMALLY HYDROLYZED KERATIN PEPTIDE SOLUTION IN ENHANCING THE YIELD AND QUALITY OF TEA LEAVES

(71) Applicant: CH Biotech R&D Co., Ltd., Nantou City (TW)

(72) Inventors: Iou-Zen CHEN, Taipei (TW); Ming-Yuan LEE, Nantou (TW); Pei Chun LIAO, New Taipei City (TW); Meng-Ying LI, Nantou (TW); Nai-Hua YE, Changhua (TW)

(73) Assignee: CH Biotech R&D Co., Ltd., Nantou City (TW)

(21) Appl. No.: 18/758,140

(22) Filed: Jun. 28, 2024

(30) Foreign Application Priority Data
Dec. 29, 2023 (TW) 112151702

(51) Int. Cl. A01N 63/50; A01N 25/02; A01P 23/00

(52) U.S. Cl. CPC A01N 63/50; A01N 25/02; A01P 23/00

(57) ABSTRACT

Present invention teaches the method of using a keratin hydrolysis peptide (“KHP”) solution to enhance the yield and quality of tea leaves. By selectively choosing specific weights of feathers and water, and treating the mixture to a high-temperature high-pressure hydrolysis process, the resulting solution is confirmed to contain at least 253 peptides and then apply to the tea trees either by infusing to the soil or by leaf spray at certain growth stages. Optionally, the KHP solution can be diluted by water, as disclosed in the specification, for soil infusing or leaf spraying.

### PRIORITY CLAIM TO FOREIGN APPLICATION

Applicant hereby makes priority claim to a Taiwan application, number 112151702, having the Taiwan filing date of Dec. 29, 2023.

### SEQUENCE LISITNG

Table I (in Sequence Listing XML format) shows the at least 253 peptides and its annotated sequences for the solution generated in accordance with the disclosure of this application. The Sequence Listing XML file complies with the WIPO ST.26 requirements. Said XML copy, created on Mar. 17, 2024, is named Table-I-253_sequence and is 216 bytes in size.

Applicant hereby incorporates by reference said Sequence Listing XML file in its entirety as part of the disclosure and specification of the present application

### BACKGROUND OF THE INVENTION

Present invention disclosed and claimed the method and application of a keratin hydrolysis peptide (“KHP”) solution to enhance the yield and quality of tea leaves.

Hydrolyzed keratin has long been used to strengthen hairs, reduce hair splitting and breakage. Other beneficial uses include skin moisturization and wound healing. Keratin hydrolysate has also been known to function as a biofertilizer, boosting plants' growth by enhancing the plants' ability to receive and utilize nutrients, including commonly applied fertilizers.

The KHP solution is made by a hydrolysis process using feathers and water, via a high-temperature and high-pressure process, resulting in a solution that has many beneficial applications in the fields of horticulture, agriculture and potentially other farming businesses.

The tea tree (Camellia Sinesis) is a type of perennial evergreen woody plant; it is also a deciduous shrub. The leaves of a tea tree are thin, in a general oval shape, with small serrated edges. The young tender leaves sprouting out during Spring or Autumn seasons are most favored portion of the tea leaves for culling and harvesting as the source materials for making into tea drinks.

The bud tips are the growth points in tea trees where the new shoots/leaves appear. At the bud tips, very tiny white furs can be seen, referred to as the “white fur”. The harvested tender leaves generally come in the types of one-bud-with-one-leaf, one-bud-with-two-leaf or one-bud-with-three-leaf. Generally, the tea leaves' harvesting stops at the one-bud-with-three-leaf stage; further harvesting after the fourth terminal-facing-leaf renders the tea leaf's age to be on the older side and the drink quality would drop.

The freshly harvest young and tender tea leaves are generally called “tea shoot”.

The deliciousness of tea shoot has a negative correlation to the age of the tea leaf: too many terminal facing leaves, with fewer bud tips, will cause the tea flavor to thin out. In other words, higher maturity of the tea leaves, as indicated by the amount of terminal facing leaves, loses the tenderness and deliciousness of the tea shoot, which is sometimes referred to as “old”.

The fertilizer of urea is commonly used in the tea tree farming. While it stimulates the budding rate and the overall tree growth, the incorrect concentration, or application timing, often leads to higher proportion of terminal facing leaves and earlier aging, as well as the polyphenol/amino acid ratio to decrease. This further affects the sufficient fermentation of tea leaves, which is the key step in the making of high-quality tea.

As such, the tea tree industry has a problem to solve: how to develop a new type of fertilization process that will promote the growth of the tea tree without advancing the aging process, and the application in the Spring season will be effective continuously to a second season, so as avoid the undesired impact of common urea fertilizer as stated earlier.

The inventors of present application prepare the KHP solutions, in accordance with the parameters disclosed herein, and apply to the tea plants during the spring sprouting period, resulting in boosted growth and development of the tea tree so that more tender leaves can sprout out without advancing the aging process of the new sprouting leaves that generate more terminal facing leaves.

### SUMMARY OF THE INVENTION

The keratin solution is primarily based upon feather, which contains 85-91% keratin, 13-15% organic nitrogen, 1.6-2% organic sulfur, as well as other materials. The high keratin content has drawn many prior researches that work to break down, by enzyme, chemical agents, or fermentation process, into peptides, amino acids and other smaller molecules that can be used for animal feeds, plant fertilizers, and cultivation bases.

Around 2019, Nurdiawati, et al, came up with a hydrolysis process, by the mixture of α-amylase and protease to hydrolyze feather waste, resulting in a mixture of amino acids, fatty acids, and sugars. Nurdiawati experimented and adopted certain specific high-temperature and high-pressure setting in the hydrolysis process and discovered that the resulting solution, when mixed with some potassium and other minerals, can boost the growth of Pogostemon cablin and Vigna radiata, as reported in International Journal of Recycling or Organic Waste in Agriculture (8:221-232, 2019).

The inventors of present application, under the aegis of CH Biotech, developed and selected different feather and water compositions to perform the hydrolysis at higher temperature and higher pressure setting, resulting with different keratin hydrolysis peptide (“KHP”) solution that can be used on different crops/plants.

The selected embodiment of present invention uses a mixture of water and feathers, and subject the mixture to a thermal hydrolysis process to create KHP solutions based upon temperature/pressure parameters as noted below.

The inventors used Dionex UltiMate 3000 UPLC to separate the peptides; an analysis is done via Thermo Orbitrap Fusion Lumos Tribrid Orbitrap mass spectrometry to identify the peptides, which are then subsequently confirmed by looking up the BIOPEP-UWM database.

The application of the KHP solution can be diluted. The range of dilution ratio between 50 times and-1,000 times (noted as 50×-1,000×) of water by volume can be done.

The inventors chose preferred dilution ratio of 125×-500×, out of the range of 50×-1,000, when applying KHP solution to the tea plants by leaf spray or soil infusion.

### BRIEF DESCRIPTION OF DRAWINGS

The accompanying drawings, figures and tables, which are incorporated in and constitute a part of this specification, illustrate and exemplify the preferred embodiments of the invention. Together with the description, serve to explain the principles of the invention.

FIG. 1A shows the tea shoot harvested weights among the three groups CK, KHP-1 and Urea in a unit area.

FIG. 1B shows the comparison of the proportions of terminal facing leaves calculated from the tea shoot among the three groups CK, KHP-1 and Urea.

FIG. 2A shows the tea shoot harvested weights among the four groups CK, KHP-1 250×, KHP-1 500× and KHP-1 1000×.

FIG. 2B shows the hundred-bud weight counts among the four groups CK, KHP-1 250×, KHP-1 500× and KHP-1 1000×.

FIG. 3 shows the evaluation points assessed by certified tasters among the four groups CK, KHP-1 250×, KHP-1 500× and KHP-1 1000×.

FIG. 4A shows the bud weights measured 9 days after KHP infusion for the three groups CK, KHP-2 125× and KHP-2 250×.

FIG. 4B shows the bud weights measured 21 days after KHP infusion for the three groups CK, KHP-2 125× and KHP-2 250×.

FIG. 5A shows the bud weights measured 6 days after the first KHP leaf spray for the three groups CK, KHP-1 500× and KHP-2 500×

FIG. 5B shows the bud weights measured 12 days after the second KHP leaf spray for the three groups CK, KHP-1 500× and KHP-2 500×.

FIG. 6 shows the leaf area comparison among the first, second, third and fourth leaves from the buds on the 21^{st} day after KHP infusion for the three groups CK, KHP-2 125× and KHP-2 250×.

FIG. 7 shows the leaf area comparison among the first, second, third and fourth leaves from the buds on the 21^{st} day after KHP leaf spray for the three groups CK, KHP-1 500× and KHP-2 500×.

FIG. 8A shows the tea shoot weights where the harvested leaves are taken above 78 cm height from the ground, for KHP solutions applied by soil infusion and leaf spray.

FIG. 8B shows the tea shoot weights where the harvested leaves are taken at height range of 68-78 cm from the ground, for KHP solutions applied by soil infusion and leaf spray.

FIG. 8C shows the weight total from the two harvesting heights, for KHP solutions applied by soil infusion and leaf spray.

### DETAILED DESCRIPTION OF THE INVENTION

The keratin hydrolysis peptide (“KHP”) solution of present invention is made by a high-temperature and high-pressure process to treat a mixture of water and feathers as shown in the parameters herein.

The KHP solution in present application of a first embodiment takes the steps of:
a. Preparing the KHP solution by mixing 66 kg of feathers whose content is 50% water and 44 kg of water in a sealed container;
b. hydrolyzing the mixture in the container with a temperature and pressure setting of 195° C. and 16 kg/cm² for a duration of 40 minutes;
c. using a mass spectrometer to confirm the combination of peptides in the solution to contain at least 253 peptides as listed in the specification where their molecular masses are between 500 and 4,000 Daltons, and the concentration is in the range of 2.0×10⁵˜4.5×10⁵ ppm.

The keratin hydrolysis peptide (KHP) solution of the first embodiment is further filtered and concentrated to 200,000 ppm concentration.

The KHP solution in present application of the second embodiment takes the steps of:
a. Preparing the KHP solution by mixing 50 kg of feathers whose content is 50% water and 40 kg of water in a sealed container;
b. hydrolyzing the mixture in the container with a temperature and pressure setting of 185° C. and 12 kg/cm² for a duration of 80 minutes;
c. using a mass spectrometer to confirm the combination of peptides in the solution to contain at least 253 peptides as listed in the specification where their molecular masses are between 500 and 4,000 Daltons, and the concentration is in the range of 2.0×10⁵˜4.5×10⁵ ppm.

The keratin hydrolysis peptide (KHP) solution of the second embodiment is further filtered and concentrated to 301,500 ppm concentration.

The confirmation of some of the 253 peptides, in both embodiments, is further done by referencing the BIOPEP-UWM database.

The mixture ratio, temperature, pressure and duration parameters are summarized below:

| | | | Water content | | | | | |
|---|---|---|---|---|---|---|---|---|
| | Feather | Water | in feather | Pressure | Temp. | Time | Mass | Concen. |
| | (kg) | (kg) | (%) | (kg/cm²) | (° C.) | (min) | (Da) | (ppm) |
| KPH-1 | 66 | 44 | 50% | 16 | 195 | 40 | 593.3~3828.0 | 200000 |
| KHP-2 | 50 | 40 | 50% | 12 | 185 | 80 | 593.3~3508.9 | 301500 |

The inventors tested the KHP solutions by two methods of application to promote the growth of tea trees without advancing the aging process or increasing the terminal facing leaves appearance: soil infusion and leaf spray.

The inventors defined a unit area of 30×30 cm² for harvesting tea shoot and measuring weights. The inventors further defined a percentage value of cease-growing bud weight relative to the total bud weight, as indication of the increased tea leaf production without advancing the bud-aging side-effect.

The inventors further defined a hundred-bud weight count for a hundred buds in a 30×30 cm² area using the formula of [total tea shoot weight]/[bud count]×100.

The inventors also retained three (3) certified tasters to provide their taste evaluations, at total points of 100, divided into four (4) categories: aroma (30%), taste (30%), color (20%) and look (20%).

The inventors conducted many experiments to compare the effectiveness of KHP-1 and KHP-2 solutions, either by soil infusion or by leaf spray, at the dilution ratios as indicated herein below.

A check group, noted as CK, indicate the application of water only, without any urea fertilizer or any embodiment of KHP solution.

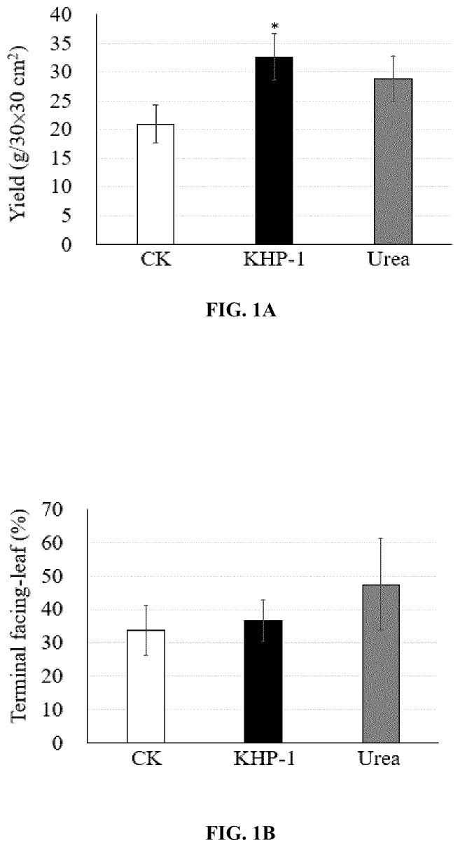

One of the experiments involves first soil infusion application one week after initial harvesting, then leaf-spraying of KHP-1 500× solution twice, first time at the one-bud-with-one-leaf stage and second time at one-bud-with-two-leaf stage. In addition to a CK group, another urea application group of 200× dilution (200 kg of water to 1 kg of urea) is also tabulated. The result is shown in FIG. 1A where the tea shoot's production for the KHP-1 500× group is 32.54 g in a 900 cm² harvest area, higher than that of the CK group (20.86 g) and urea group (28.69 g).

When measuring the proportion of terminal facing leaves expressed as percentages, the KHP-1 group (500× dilution) is 36.6%, only slightly higher than that of the CK group (at 33.6%), whereas the urea group comes in at a much higher 47.4%. This is reflected in FIG. 1B.

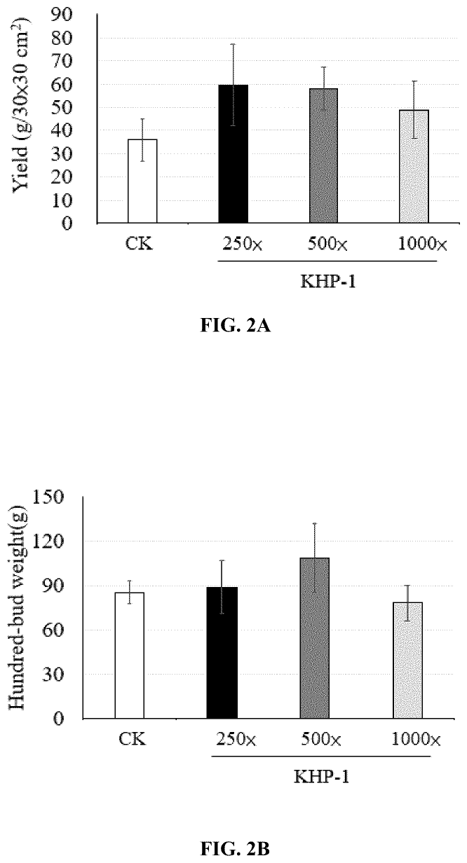

Further experiment conducted by the inventors was done at a second growth season during Summer (after the spring harvesting where the leaf spray was done twice, at one-bud-with-one-leaf and one-bud-with-two-leaf stages as described earlier) where KHP-1 solutions at 3 dilution ratios of 250×, 500× and 1,000× are leaf-sprayed to the tea trees. A CK group of tea trees are sprayed with water only. Tea shoots from a unit area of 900 cm² are collected and measured, tabulated into FIGS. 2A and 2B.

FIG. 2A shows the increased tea shoot weight, in a unit area of 900 cm² over that of the CK group. The KHP-1 1000× group has tea shoot weight of 48.80+/−12.45 g; the KHP-1 500× group has tea shoot weight of 57.83+/−9.30 g; and the KHP-1 250× group has 59.6+/−17.47 g. All show superior tea shoot production yields.

For the hundred bud-weight count, FIG. 2B shows the KHP-1 250× and KHP-1 500× to have superior tea shoot production yield. The KHP-1 500× group comes in at 108.5+/−23.71 g; the KHP-1 250× group comes in at 88.95+/−17.96 g. Both are higher than the CK group's 85.27+/−7.61 g.

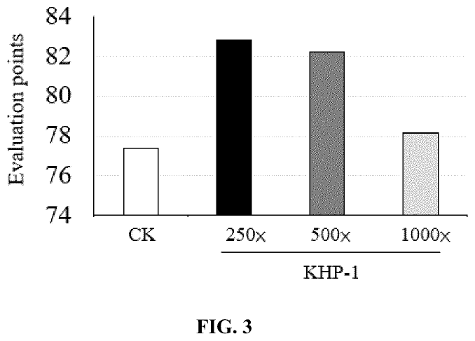

From the tea shoot (one-bud-with-two-leaf) harvested at the second (Summer) season, the inventors use 150 ml of boiling water to make tea drink from 3 g of the tea shoot and asked the certified tasters to score the tea from the four groups: CK, KHP-1 250×, KHP-1 500× and KHP-1 1000×, based upon the four categories defined previously. FIG. 3 shows the KHP-1 250× at 82.85 points and the KHP-1 500× at 82.25, while the KHP-1 1000× at 78.12 points, all are higher than the CK group's 77.37 points.

The inventors experimented the KHP solutions on low-elevation tea trees, by infusing the soil with KHP-2 125× and KHP-2 500× solutions. Same as before, tea trees in CK group are given water only. The soil infusion is done 4 times after the initial nutritional liquids are used up.

The experiment on low-elevation tea trees also includes KHP application by leaf spraying with KHP-1 500× and KHP-2 500× solutions. The leaf spraying is done twice: at one-bud-with-one-leaf and one-bud-with-two-leaf stages.

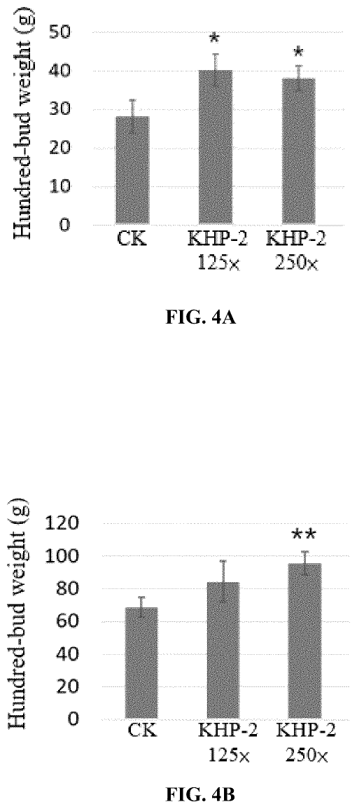

On the 9th and 21^{st} days after the fourth soil infusion, the tea shoot hundred-bud weights are measured and tabulated into FIG. 4A and FIG. 4B.

As shown inf FIG. 4A, on the 9th day, the hundred-bud weight in the KHP-2 125× group is 40+/−4 g, the hundred-bud weight in the KHP-2 250× group is 38+/−3 g; both are higher than the 28+/−4 g of the CK group.

As shown in FIG. 4B, on the 21^{st} day, the hundred-bud weight in the KHP-2 125× group is 84+/−13 g, the hundred-bud weight in the KHP-2 500× group is 95+/−7 g; both are higher than the 68+/−6 g of the CK group.

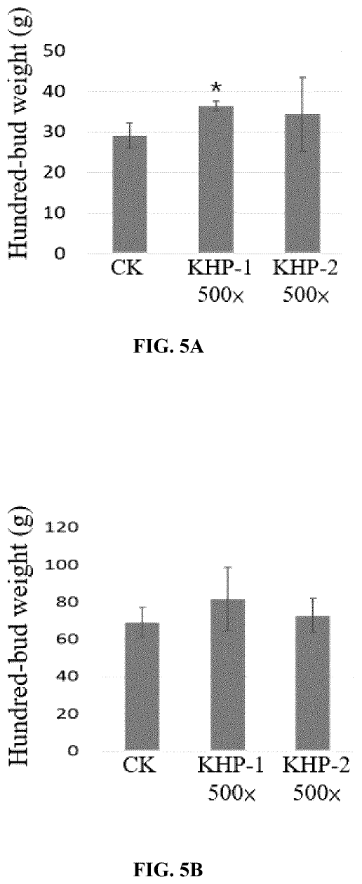

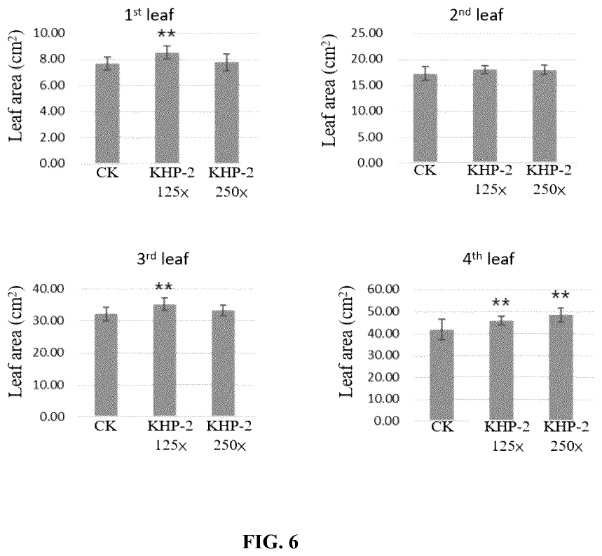

On the 6th day after the first leaf spray and on the 12^{th} day after the second leaf spray, the hundred-bud weights in the three groups are measured and tabulated into FIGS. 5A and 5B: CK, KHP-1 500× and KHP-2 500×.

As shown in FIG. 5A, on the 6th day after the first KHP leaf spray, the hundred-bud weight in the KHP-1 500× group is 36+/−1 g, the hundred-bud weight in the KHP-2 500× group is 34+/−9 g; both are higher than the 29+/−3 g of the CK group.

As shown inf FIG. 5B, on the 12th day after the second KHP leaf spray, the hundred-bud weight in the KHP-1 500× group is 82+/−17 g, the hundred-bud weight in the KHP-2 500× group is 73+/−9 g; both are higher than the 69+/−8 g of the CK group.

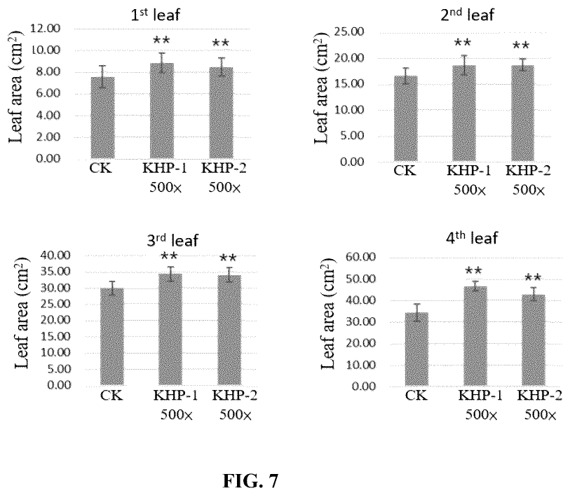

The inventors used a leaf analysis system (WinFOLIA Pro LA 2400, Regent Instruments, Inc.) to scan and calculate leaf surface area of the first, second, third and fourth leaves from the buds on the 21^{st} day after the fourth soil infusion and the 12^{th} day after the second leaf spray. The results are tabulated into FIGS. 6 and 7.

As shown in FIG. 6, the leaf area measured (in cm²) from the first to the fourth leaves, on the 21^{st} day after KHP soil infusion are: 8.49+/−0.53, 17.94+/−0.75, 35.13+/−1.87 and 45.66+/−2.06 in the KHP-2 125× group; 7.75+/−0.65, 17.88+/−0.93, 33.15+/−1.69 and 48.33+/−3.07 in the KHP-2 250× group. All the measured figures with KHP solution infusion are better than the CK group's figures.

As shown in FIG. 7, the leaf area measured (in cm²) from the first to the fourth leaves, on the 12^{th} day after second KHP leaf spray are: 8.81+/−0.87, 18.57+/−1.88, 34.18+/−2.21 and 45.66+/−2.06 in the KHP-1 500× group; 8.42+/−0.81, 18.61+/−1.1, 33.86+/−2.23 and 42.78+/−2.97 in the KHP-2 500× group. All the measured figures with KHP leaf spray are better than the CK group's figures.

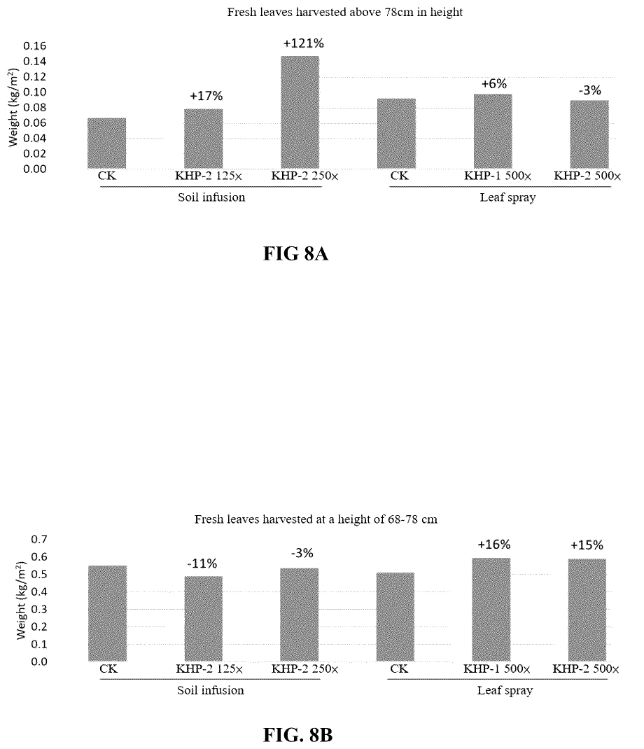

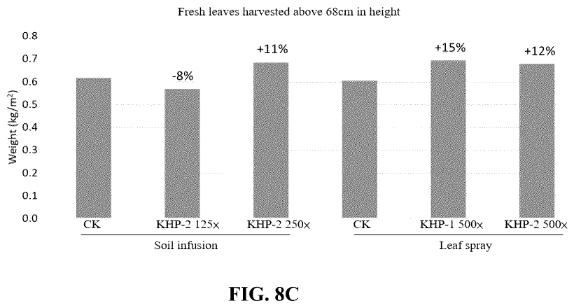

The investors set a range of target height where tea leaves are harvested to measure the production yield of tea shoot in a unit area. Three groups are treated with KHP solution infused into the soil: CK, KHP-2 125× and KHP-2 250×. Three groups are treated with KHP solution receiving leaf spray: CK, KHP-1 500×, and KHP2-500×. The CK groups are treated with water only, without any kind of KHP solution. The results are tabulated into FIGS. 8A, 8B and 8C.

FIG. 8A reflected the comparison of tea shoot weight per square meter when harvesting was done at the tea tree with KHP solutions, at height of 78 cm. The three groups on the left are treated with soil infusion (the CK group received water only). The KHP-2 125× group shows 0.078 kg per square meter; the KHP-2 250× group shows 0.147 kg per square meter. Both are higher than that of CK group, at 0.067 kg per square meter, at increase percentage of 17% and 121%. The three groups on the right are treated with leaf spray, the KHP-1 500× group shows 0.098 kg per square meter, the KHP-2 500× shows 0.089 kg per square meter. The KHP-1 500× group's tea shoot is 6% higher than that of the CK group.

FIG. 8B reflected the comparison of tea shoot weight per square meter when harvesting was done at the tea tree with KHP solutions, at height of 68 cm. The three groups on the left are treated with soil infusion (the CK group received water only). There is no discernible effect to the tea shoot production yield in the three groups on the left. The three groups on the right are treated with leaf spray, the KHP-1 500× group shows 0.598 kg per square meter, the KHP-1 500× shows 0.588 kg per square meter. The KHP-1 500× and KHP-2 500× groups' increase percentage are 16% and 15% respectively over that of the CK group.

FIG. 8C reflects the sum total of two tea shoot harvestings, with the three groups of soil infusion on the left and the three groups of leaf spray on the right. As can be seen, other than the KHP-2 125× infusion, other method of KHP applications all increased the tea shoot production weight, over the CK group, by 11%, 15% and 12%.

Based upon the tests and experiments done by the inventors, it is confirmed that application of the KHP solutions, at the dilution ratios and manner of application as disclosed herein, effectively increased the production of tea leaves without advancing the bud aging side effect.

While the disclosure herein gave limited teachings and embodiment examples, it should be noted that the description and disclosure made herein illustrated the preferred embodiments of the invention and are not meant to limit the scope of the applicant's rights. Variations and alterations may be employed for yet additional embodiments without departing from the scope of the invention herein.

1. A method of using a keratin hydrolysis peptide (KHP) solution to enhance the yield and quality of tea leaves, comprising the steps of:
a. Preparing the KHP solution by mixing 66 kg of feathers whose content is 50% water and 44 kg of water in a sealed container;
b. hydrolyzing the mixture in the container with a temperature and pressure setting of 195° C. and 16 kg/cm² for a duration of 40 minutes;
c. using a mass spectrometer to confirm the combination of peptides in the solution to contain at least 253 peptides as listed in the specification where their molecular masses are between 500 and 4,000 Daltons, and the concentration is in the range of 2.0×10⁵˜4.5×10⁵ ppm; and
d. applying the KHP solution by either soil infusion or leaf spray.

2. The method of using a keratin hydrolysis peptide solution of claim 1 wherein the soil infusion application of KHP solution is done one week after initial harvesting.

3. The method of using a keratin hydrolysis peptide solution of claim 2 wherein the solution is diluted with water by volume at the ratio of 1:50-500.

4. The method of using a keratin hydrolysis peptide solution of claim 1 wherein leaf spray application of KHP solution is done at the one-bud-with-one-leaf and one-bud-with-two-leaf stages.

5. The method of using a keratin hydrolysis peptide solution of claim 4 wherein the solution is diluted with water by volume at the ratio of 1:50-500.

6. A method of using a keratin hydrolysis peptide (KHP) solution to enhance the yield and quality of tea leaves, comprising the steps of:
a. Preparing the KHP solution by mixing 50 kg of feathers whose content is 50% water and 40 kg of water in a sealed container;
b. hydrolyzing the mixture in the container with a temperature and pressure setting of 185° C. and 12 kg/cm² for a duration of 80 minutes;
c. using a mass spectrometer to confirm the combination of peptides in the solution to contain at least 253 peptides as listed in the specification where their molecular masses are between 500 and 4,000 Daltons, and the concentration is in the range of 2.0×10⁵˜4.5×10⁵ ppm; and
d. applying the KHP solution by either soil infusion or leaf spray.

7. The method of using a keratin hydrolysis peptide solution of claim 6 wherein soil infusion application of KHP solution is done one week after initial harvesting.

8. The method of using a keratin hydrolysis peptide solution of claim 7 wherein the solution is diluted with water by volume at the ratio of 1:50-500.

9. The method of using a keratin hydrolysis peptide solution of claim 6 wherein leaf spray application of KHP solution is done at the one-bud-with-one-leaf and one-bud-with-two-leaf stages.

10. The method of using a keratin hydrolysis peptide solution of claim 9 wherein the solution is diluted with water by volume at the ratio of 1:50-500.
